(19) United States
(12) Patent Application Publication
(10) Pub. No.: US 2012/0113056 A1
(43) Pub. Date: May 10, 2012

(54) INPUT DEVICE, INPUT METHOD, AND COMPUTER READABLE STORAGE DEVICE

(75) Inventor: Yoshihiro KOIZUMI, Tokyo (JP)

(73) Assignee: Sony Corporation, Minato-ku (JP)

(21) Appl. No.: 13/252,263

(22) Filed: Oct. 4, 2011

(30) Foreign Application Priority Data
Nov. 9, 2010 (JP) 2010-250791

(51) Int. Cl. G06F 3/042

(52) U.S. Cl. 345/175

(57) ABSTRACT

An input device, method and computer program storage device cooperate to assist in controlling an input device. In the device, a detector detects a presence of an object that is within a first predetermined distance of a detection surface. The detector also detects when the object is within a second predetermined distance of the detection surface. A controller executes a first processing operation when the detector detects the object being within the first predetermined distance, and subsequently executes a related second processing operation when the detector detects the object being within the second predetermined distance.

### BACKGROUND

The present disclosure relates to an input device, an input method, and a computer readable storage device for providing instruction of two or more functions relating to control objects, such as electronic devices, in a non-contact type.

In the related art, the type of pushing a mechanical shutter button with a finger is the most general as the operation of taking a still image by a user with a camera or the like. However, this type is accompanied with a problem of unstableness due to shaking of the camera main body when the button is pushed. In particular, in photographing under a condition that intensifies focusing or imaging a dark place, since a mode of long exposure time is implemented, the influence of the unstableness in considerably increased. In order to avoid this problem, some technologies of implementing an operation of photographing a series of still images with a non-contact operation which is not accompanied with pushing of the mechanical shutter button have been proposed. In general, a non-contact operation is implemented by using a touch panel in many cases, but recently, the non-contact operation is implemented even without using a touch panel.

In Japanese Unexamined Patent Application Publication No. 06-160971, a technology of using an operation of a photographer approaching a finger for non-contact photographing has been proposed. In this method, when a photographer approaches a finger over a photo reflector, the reflected light is received by a light receiving element and converted into voltage corresponding to the amount of light. The photographing operation is started by considering that the voltage reaches a predetermined threshold value as a trigger.

In Japanese Unexamined Patent Application Publication No. 2006-14074, a technology of using an operation of a photographer approaching fingers, as a use of a mobile phone, to non-contact image has been proposed. In this method, an optical sensor is mounted in a mobile phone and the photographing operation is started by considering that incident light is blocked by a photographer's finger or the like and changed such that the amount of light decreases, as a trigger.

### SUMMARY

However, the technologies of Japanese Unexamined Patent Application Publication No. 06-160971 and Japanese Unexamined Patent Application Publication No. 2006-14074 both have a problem in that the camera main body is equipped with a device only for detection as a unit for a non-contact operation, other than a touch panel, such that the cost increases. Further, recently, since the size and thickness of cameras are decreased for a demand in the market, it is not desirable to mount the detection-exclusive device even in view of decreasing the number and amount of the parts.

Further, in Japanese Unexamined Patent Application Publication No. 06-160971 and Japanese Unexamined Patent Application Publication No. 2006-14074, since the range where a finger can be detected by the photo reflector or the optical sensor is limited, the region available for detection of the user's finger for considering the capturing operation as a trigger is narrowly limited. Further, in the following description, the capturing is to record an image signal obtained by an image element on a recording device, which is discriminated as display of a live view image.

Further, since the photo reflector or the optical sensor is considered only a unit only for the capturing operation, an instruction of a photographing-ready operation that is necessary as the previous step (auto-focus scanning or auto-exposure adjustment) is provided by another method. Accordingly, individual operations for two connected functions are approximately simultaneously performed, such that it is complicated for the user to operate.

Further, even though a touch panel is used as a unit for implementing a non-contact operation, when a user wants to perform two connected functions, an individual operation, such as displaying a specific softkey by changing the menu, is necessary.

It is desirable to make it possible to perform two or more functions (operations) connected with each other by user's seamless (a series of) operations. Accordingly, in one embodiment, an input device includes
a detector that
   detects a presence of an object that is within a first predetermined distance of a detection surface, and
   detects when the object is within a second predetermined distance of the detection surface; and
a controller that executes a first processing operation when the detector detects the object being within the first predetermined distance, and subsequently executes a related second processing operation when the detector detects the object being within the second predetermined distance.

In an aspect of the input device the controller uses a setting established by the first processing operation when executing the second processing operation.

In another aspect of the input device the detector and controller are disposed in a portable imaging device.

In another aspect of the input device the portable imaging device being at least one of a video recorder, digital camera, and a tablet computer.

In another aspect of the input device, the device further includes
an image sensor; and
a display that displays a live image during the first processing operation, wherein
the second processing operation includes capturing and recording an image.

In another aspect of the input device
the first processing operation includes using multi Auto Focus over a plurality of auto focus regions.

In another aspect of the input device
when the detector detects the object within the first predetermined distance, the detector also detects a vertically projected position of the object with respect to the detection surface, and
the controller determines an operational mode of the device based on the vertically projected position.

In another aspect of the input device
when the vertically projected position falls within a first area on the detection surface the controller places the device into a spot Auto Focus/Auto Exposure mode.

In another aspect of the input device
when the vertically projected position is detected as being moved to a second area on the detection surface, the controller places the device into a multi Auto Focus mode.

In another aspect of the input device
when the vertically projected position is subsequently detected as being returned to the first area on the detection surface, the controller returns the device into the spot Auto Focus/Auto Exposure mode.

In another aspect of the input device
the second processing operation includes an image recording operation, and
when the detector detects the object being moved closer than the second predetermined distance, the controller executes the image recording operation.

In another aspect of the input device
when in the first processing operation, the detector detects the object being moved beyond the first predetermined distance, the controller returns the device to a normal mode.

In another aspect of the input device
when the vertically projected position falls within a first area on the detection surface, the controller places the device into a multi Auto Focus mode.

In another aspect of the input device
when the vertically projected position is detected as being moved to a second area on the detection surface, the controller places the device into a spot Auto Focus mode.

In another aspect of the input device
when the vertically projected position is subsequently detected as being returned to the first area on the detection surface, the controller returns the device into the multi Auto Focus/Auto Exposure mode.

In another aspect of the input device
the second processing operation includes an image recording operation, and
when the detector detects the object being moved closer than the second predetermined distance, the controller executes the image recording operation.

In another aspect of the input device
when in the first processing operation, the detector detects the object being moved beyond the first predetermined distance or detects the vertically projected position being moved outside of a multi Auto Focus detection area, the controller returns the device to a normal mode.

In another aspect of the input device, the device further includes
a display, wherein
the first processing operation includes locking a spot auto focus operation within a displayed image at a corresponding position on the detection surface that is proximate to the object, and
the controller causes a display of an indication of the spot auto focus being locked until the object is moved beyond a detection range of the detector.

In another aspect of the input device, the device further includes
a display, wherein
the first processing operation includes locking a multi auto focus operation at a plurality of areas, and
the controller causes a display of an indication of the multi auto focus operation being locked until the object is moved beyond a detection range of the detector.

In another aspect of the input device
the detector is configured to detect when the object has moved within a third predetermined distance of the detection surface, and
when the device is in the first processing operation or the second processing operation, the controller causes the device to change to a normal mode when the object is detected as moving to the third predetermined distance, wherein the third predetermined distance is further than the first predetermined distance or second predetermined distance.

In another aspect of the input device
the controller executes an image capture and recording operation when the detector detects the object as moving to a distance further than the second predetermined distance, the second predetermined distance being greater than the first predetermined distance.

In another aspect of the input device
the controller adjusts an image transmission speed on a display as a function of a distance between the object and the detection surface.

In another aspect of the input device, the device further includes
an image sensor, wherein
the first processing operation includes a multi Auto Exposure mode that controls an image exposure for a plurality of regions in a field of view of the image sensor.

In another aspect of the input device
the detector includes a transparent capacitance touch panel.

In another aspect of the input device
the detector is at least one of
   an electromagnetic induction touch panel,
   an optical touch panel, and
   and image recognition touch panel.

In another aspect of the input device
the controller sets the device in an image transmission mode based on a projected position of the object being detected within a predetermined area, and changes the image transmission speed based on the distance of the object to the detection surface.

In another aspect of the input device
when the object is detected as being a constant distance from the detection surface, the image transmission speed is held constant.

In another aspect of the input device
when the object is detected as being further than a third predetermined distance from the detection surface, the transmission speed is stopped.

In another aspect of the input device
when the object is detected as being less than a third predetermined distance from the detection surface, the transmission speed is renewed at a higher constant speed than a constant speed prior to being stopped.

In another aspect of the input device, the device further includes
a display; and
a storage device that has video stored therein, wherein
the controller adjusts a playback speed of the video based on a distance of the object to the detection surface.

According to an input control method embodiment, the method includes
detecting with a detector a presence of an object that is within a first predetermined distance of a detection surface;
executing with a controller a first processing operation when the detector detects the object being within the first predetermined distance;
detecting with the detector a second predetermined distance of the object to the detection surface; and
executing a related second processing operation when the detector detects the object being within the second predetermined distance.

According to a non-transitory computer readable storage device embodiment having instructions stored therein that when executed by a processing circuit perform an input control method including
detecting a presence of an object that is within a first predetermined distance of a detection surface;
executing with the processing circuit a first processing operation when the detector detects the object being within the first predetermined distance;
detecting a second predetermined distance of the object to the detection surface; and
executing a related second processing operation when the detector detects the object being within the second predetermined distance.

According to the embodiment of the present disclosure, it is possible to perform two or more functions (operations) connected with each other by user's seamless (a series of) operations.

### BRIEF DESCRIPTION OF THE DRAWINGS

FIG. 1 is a schematic configuration diagram showing an imaging device according to a first embodiment;

FIG. 2 is a diagram illustrating a multi AF function;

FIG. 3 is a block diagram showing a hardware configuration of the imaging device;

FIG. 4A is a front perspective view of the image device and FIG. 4B is a rear perspective view of the imaging device;

FIG. 5 is an illustrative diagram showing an example of an input operation in photographing according to the first embodiment;

FIG. 6 is a flowchart showing an example of an imaging operation according to the first embodiment;

FIG. 7 is a flowchart showing an example of a process in step S14 (in spot AF/AE control) shown in FIG. 6;

FIG. 8 is a flowchart showing an example of a process in step S15 (in multi AF/AE control) shown in FIG. 6;

FIG. 9 is a flowchart showing an example of a process in step S16 (in photographing/recording operation) shown in FIG. 6;

FIG. 10 is an illustrative diagram showing an example of an input operation in photographing according to a second embodiment;

FIG. 11 is a flowchart showing an example of an imaging operation according to the second embodiment;

FIG. 12 is an illustrative diagram showing an example of an input operation in photographing according to a third embodiment;

FIG. 13 is a flowchart showing an example of an imaging operation according to the third embodiment;

FIG. 14 is an illustrative diagram showing an operation relating to reproduction of an image (image transmission) according to a fourth embodiment;

FIG. 15 is an illustrative diagram showing an operation relating to reproduction of an image (image return) according to the fourth embodiment; and

FIG. 16 is a characteristic diagram showing the relationship between image transmission continuation process speed and the distance between a finger and a touch panel.

### DETAILED DESCRIPTION OF EMBODIMENTS

Hereinafter, embodiments of the present disclosure are described with reference to the accompanying drawings.

The description is performed in the following order. Further, the common components in the drawings are given the same reference numerals and the repetitive description is not provided.

1. First Embodiment (Example of Implementing Two Functions Relating to Setting of Two Different Distance)

2. Second Embodiment (Example of Implementing Three Functions Relating to Setting of Three Different Distance)

3. Third Embodiment (Example of Inverting Setting of Distance for Two Operation for First Embodiment)

4. Fourth Embodiment (Example of Application for Reproduction)

### 1. First Embodiment

### [Schematic Configuration of Imaging Device]

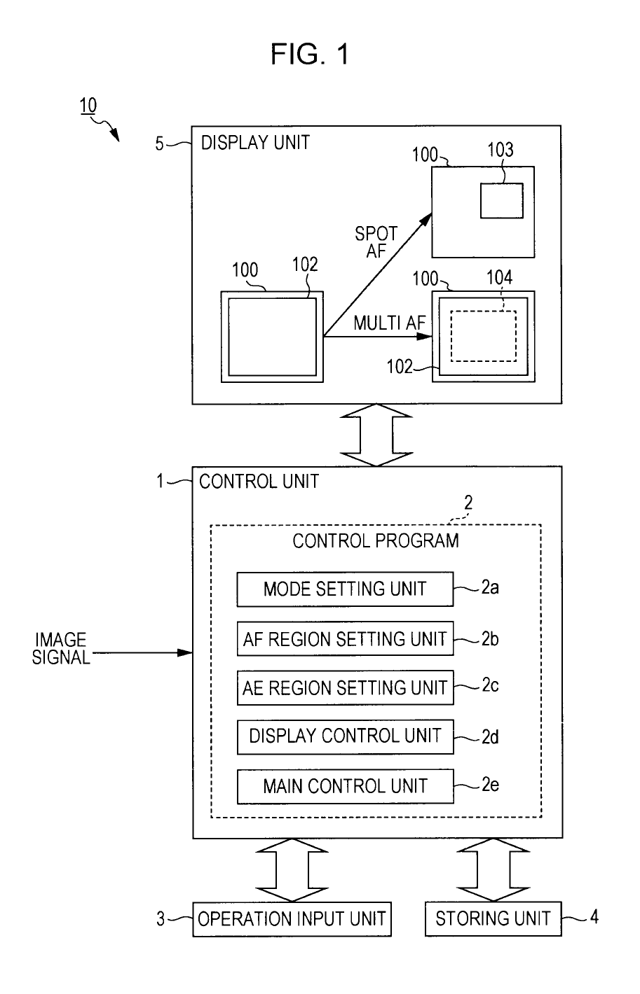

First, schematic configurations of a first embodiment of an input device where the present disclosure is applied and an imaging device according to a first embodiment are described with reference to FIG. 1. FIG. 1 is a schematic configuration view showing an imaging device 10 according to the embodiment.

As shown in FIG. 1, an imaging device 10 according to the embodiment can be applied to a digital camera (for example a digital still camera) that can image at least a still image, for example. The digital camera can be a standalone camera, or incorporated into another device, such as a tablet computer or smartphone. For convenience, the present embodiment will be described in a standalone digital camera context, but it should be understood that the invention can also be practiced when the imaging device 10 is incorporated in another device, such as a smartphone or tablet computer.

The imaging device 10 images an object and records the still image obtained by the imaging on a record medium as a digital image data. The imaging device 10 has an autofocus (hereafter, referred to as “AF”) function for automatically focusing a lens device (not shown) on an object and an autoexposure (hereafter, referred to as “AE”) function for automatically adjusting exposure of an taken image.)

As shown in FIG. 1, the imaging device 10 according to the embodiment includes a control unit 1 that controls the entire operation of the imaging device 10, an operation input unit 3 that receives an input operation from a user for the imaging device 10, and a storage unit 4 that is implemented by a record medium, such as a semiconductor memory. Further, the imaging device includes a display unit 5 that is implemented by a liquid crystal display (LCD) or the like which displays an image generated by an input operation or the like on the operation input unit 3.

The control unit 1 reads out a control program 2 stored in the storage unit 4 and, for example, functions as a mode setting unit 2a, an AF region setting unit 2b, an AE region setting unit 2c, a display control unit 2d, and a main control unit 2e.

The control unit 1 sets a mode of the imaging device 10 by the mode setting unit 2a. In more detail, the mode, for example, includes an AF mode, such as a multi AF mode or a spot AF mode, and an AE mode, such as a multi AE mode or a spot AE mode. The mode setting unit 2a may set the modes on the basis of input operations from a user through the operation unit 3 or may automatically set the modes in accordance with imaging conditions.

The multi AF mode is a mode that performs AF control for a plurality of regions or points within a taken image (an imaging range), and is also called multi-area AF or multi-point AF. In the multi AF ode, as compared with the spot AF mode, a multi AF region (a region within a multi AF detection box 104) in a relatively wide region (for example, the entire region of a screen or a predetermined region from the center of a screen) in a screen 100 of the display unit 5. Accordingly, focus slide is automatically performed on the basis of the corresponding wide multi AF region. The multi AF detection box 104 is set within an AF detection available box 102 showing the maximum region where AF detection is available in the screen 100.

In general, in the multi AF mode, a predetermined range around the center of the screen 100 of the display unit 5 is divided into a plurality of regions (or points) and AF control is performed for the plurality of regions (AF regions). The mounting cost of the imaging device 10 is limited to the number of the AF regions (or points) and the arrangement position in connection with the process cost, but the multi AF can be theoretically performed for the entire imaging device 100.

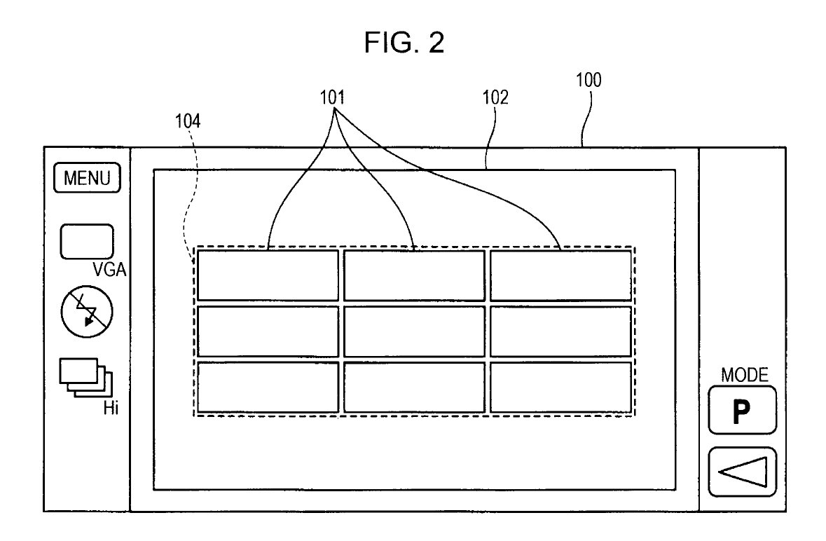

Meanwhile, the sport AF mode is a mode that performs AF control for a relatively narrow sport AF region (a region in a spot AF detection box 103) that can be set at any position in a taken image (within an imaging range). In the spot AF mode, focus slide on a very small object or narrow area can be performed by moving the spot AF detection box 103 to any position on the screen, in accordance with the positional designation of a user through the operation input unit 3. In the multi AF mode, as shown in FIG. 2, focusing on an object in a wide range is performed providing the plurality of AF region 101 in a wide range on the multi AF detection box 104.

Therefore, it is possible to take a focused image in some regions in the multi AF box 104 only by inputting an instruction for photographing (for example, pressing down the shutter) by the user. However, it is difficult to consider that the object at the position that the user intends is focused, depending on the state of the object. In the spot AF mode, the user sets any region (spot AF detection box 103) in the AF detection available box 102 as the AF region, in which control of certainly focusing the intended object can be performed by making the range of AF narrow to a predetermined position.

The AF region setting unit 2b sets the AF region (multi AF region or spot AF region) within the imaging range (that is, the AF detection available box 102 of the display unit 5). The AF region setting unit 2b sets the multi AF detection box 104 (a configuration composed of a plurality of AF regions 101) within a predetermined range around the center of the screen 100. Further, the AF region setting unit 2b can set the spot AF detection box 103 at any position in the AF detection available box 102 in accordance with position designation of the user through the operation input unit 3 (corresponding to a position designation receiving unit).

Further, the multi AE mode, as the multi AF mode, is a mode that sets a relatively wide region in the screen 100 as a multi AE region and controls exposure of an image for a plurality of regions or points included in the corresponding AE region. In the multi AE mode, exposure can be adjusted for the object in a wide range on the screen 100.

Meanwhile, the spot AE mode, as the spot AF mode, is a mode that controls exposure for a relatively narrow AE region (a region in the spot AE box) that can be set to any position in the taken image (within the imaging range). In the spot AE mode, exposure can be performed for a very small object or narrow area by moving the spot AE detection box to any position on the screen, in accordance with the positional designation of a user through the operation input unit 3.

The AE region setting unit 2c sets the AE region (multi AF region or spot AF region) within the imaging range (that is, the AE detection available box 102 of the display unit 5). In the embodiment, the multi AE region is set to the region the same as the multi AF region. Further, the multi AE region may be set to the same region as the spot AF region and may be set to any region in the screen 100.

The AE region setting unit 2c may be set the AE region at the center of the AF region set to any position in the imaging range (in the AF detection available box 102). Accordingly, since the AE region is set to the center of the AF and exposure can be adjusted for the object focused by the AF process, it is possible to improve image quality of the taken image.

The display control unit 2d controls a display process by the display unit 5. For example, the display control unit 2d controls the display unit 5 to overlap and display the spot AF detection box 103 representing the AF region set by the AE region setting unit 2c or the plurality of AF region 101, on the image displayed on the screen 100. The user can recognize whether the multi AF mode is the spot AF mode now, from the spot AF detection box 103 or the plurality of AF regions 101 displayed on the display unit 5. Further, it is possible to recognize that the object in the spot AF detection box 103 or the AF region 101 is the object to be focused.

Further, the display control unit 2d displays the information representing whether a focusing process is finished for the object included in the AF region, on the display unit 5. For example, the display control unit 2d performs a display change of the color of the AF box in accordance with the focusing state such that the spot AF detection box 103 or the box of the AF region 101 is displayed by a white color for a non-focused case and a green color for a focused case. As described above, the user can easily recognize whether the focusing process by the focusing unit of the imaging device 10 is finished, by displaying the information representing whether the focusing process is finished. Further, the display unit 2d displays, for example, the AF detection available box 102 on the display unit 5, as the information representing the range where the AF region can be designated.

Therefore, the user can recognize the range where the spot AF region is set, such that the user can appropriately perform position designation of the spot AF box, using the operation input unit 3.

The main control unit 2e controls various process operations that the imaging device 10 performs. The main control unit 2e includes an image control unit that control an imaging process of an object, a focusing control unit that controls a focusing process for the object, a exposure control unit that controls an exposure adjusting process in imaging, an photographing/recording control unit that controls a signal process of the taken image and a recording process for a record medium, and a reproduction control unit that controls a reproduction process of the image recorded in the record medium.

The imaging device 10 described above is used in the operation method to the multi AF mode and the spot AF mode according to the embodiment. For example, a touch panel that can be operated in a non-touch type is used as a receiving unit for both of the position designation operation for designate the position of a motion image (live view image) obtained by imaging an object and the mode switching operation of the multi AF mode and the sport AF mode. An photographing/recording process is performed by tapping a detection surface on which a tap for the touch panel, that is, an electrode is layered, or making a hitting motion with a finger close to the detection surface.

### [Hardware Configuration]

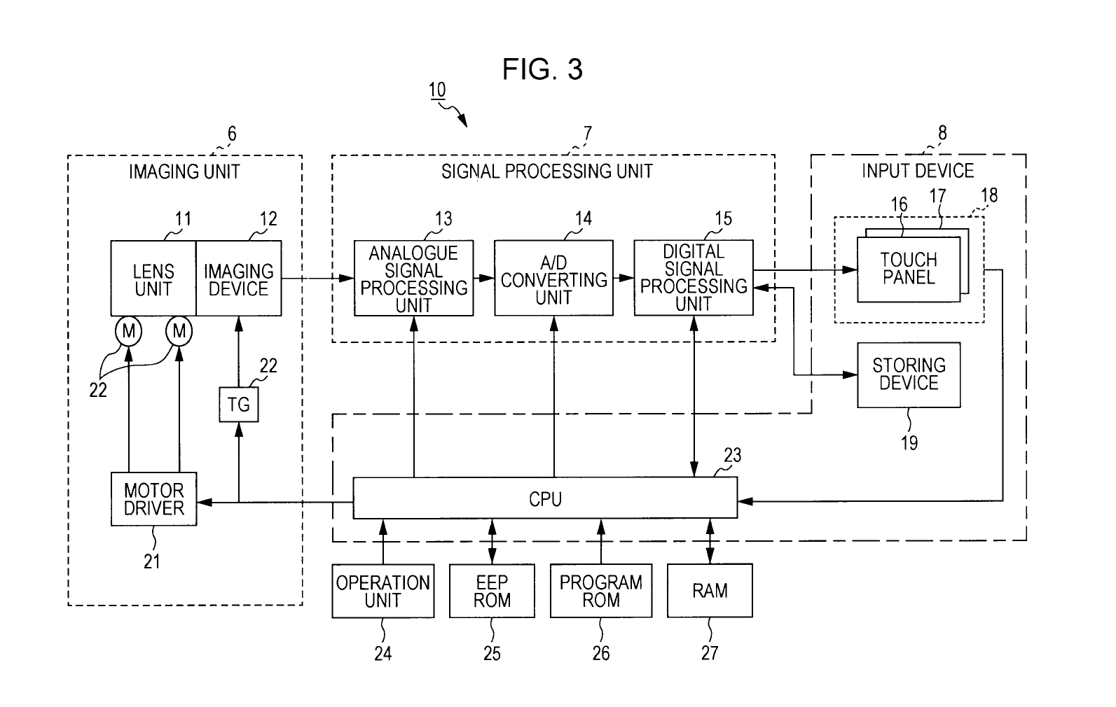

Next, the hardware configuration of the imaging device 10 is described in detail. FIG. 3 is a block diagram showing a hardware configuration of the imaging device 10.

As shown in FIG. 3, the imaging device 10 according to the embodiment includes a main imaging unit 6, a signal processing unit 7, and an input device 8.

For example, a lens unit 11 including an optical system (not shown), such as a photographing lens, a diaphragm, a focus lens, and a zoom lens, is disposed in the imaging unit 6. An imaging element 12, such as a CCD (Charge Coupled Device) and a CMOS (Complementary Metal Oxide Semiconductor), are disposed on the light path of object light incident through the lens unit 11. The imaging element 12 outputs an image signal by photoelectrically converting an optical image collected on an imaging surface by the lens unit 11.

An output portion of the imaging element 12 is connected with an input portion of a digital signal processing unit 15 through an analog signal processing unit 13 and an analog/digital (A/D) converting unit 14. The output portion of the digital signal processing unit 15 is electrically connected to a liquid crystal panel 17 and a recording device 19. The analog signal processing unit 13, the A/D converting unit 14, and the digital signal processing unit 15 constitute the signal processing unit 7. The signal processing unit 7 performs a predetermined signal process for an image signal output from the imaging element 12 and outputs the image signal after the signal process to the liquid crystal panel 17 or the recording device 19.

An actuator 20 that is a driving mechanism for adjusting the diaphragm or moving the focus lens is mechanically connected to the lens unit 11. The actuator 20 is connected to a motor driver 21 for performing driving control. The lens unit 11, the imaging element 12, the actuator 20, and the motor driver 21, and a TG 22 constitute the imaging unit 6. The imaging unit 6 images the object and outputs an image signal obtained from the imaging to the signal processing unit 7.

The motor driver 21 controls the operation of the parts in the imaging unit 6 on the basis of instructions from a CPU 23. For example, the motor driver 21, in imaging, drives the zoom lens, the focus lens, and the diaphragm by controlling the driving mechanism of the imaging unit 6 such that the object is imaged with appropriate focus and exposure, in accordance with the user's operation through the touch panel 16 or the operation unit 24. Further, the timing generator (TG) 22 outputs a timing signal for controlling the imaging timing of the imaging element 12 to the imaging element 12 on the basis of an instruction from the CPU 23.

Further, the CPU 23 (Central Processing Unit) corresponding to the control unit 1 (see FIG. 1) controlling the entire imaging device 10 is disposed in the imaging device 10. The CPU 23 is connected with the motor driver 21, the TG 22, the operation unit 24, an EEPROM (Electrically Erasable Programmable ROM) 25, a program ROM (Read Only Memory) 26, a RAM (Random Access Memory) 27, and the touch panel 16.

The CPU 23 reads out a control program stored in a record medium, such as the program ROM 26, and functions as the mode setting unit 2a, the AF region setting unit 2b, the AE region setting unit 2c, the display control unit 2d, and the main control unit 2e, shown in FIG. 1. Further, the CPU 23 and the imaging unit 6 function as a focusing unit that automatically focuses an object included in a predetermined AF region within the imaging range by the imaging unit 6. Further, the CPU 23 and the imaging unit 6 function as an exposure adjusting unit that automatically adjust exposure (AE control) of an image for a predetermined AE region within the imaging range.

The touch panel 16 is a transparent capacitance type touch panel overlapping the surface of the liquid crystal panel 17. The touch panel 16 and the liquid crystal panel 17 constitute the touch screen 18. The touch screen 16 is a position designation receiving unit (coordinate detecting unit) that receives the input operation from the user. The liquid crystal panel 17 corresponds to the display unit 5 (see FIG. 1).

A uniform electric field is formed throughout the surface of the touch panel 16 by a touch panel driving circuit, such that when the user approaches a finger or an exclusive touch pen to the touch panel 16, capacitive coupling according to the access distance is locally formed between the touch panel 16 and the finger or the exclusive touch pen. The touch panel 16 detects the capacitive coupling and outputs a signal based on the capacitance according to this state to the CPU 23. Accordingly, the CPU 23 acquires three-dimensional coordinate information including the coordinates (xy coordinates) of the position where the approached finger or the exclusive pen in the normal line of the detection surface of the touch panel 16 is projected on the detection surface, and the distance (z coordinate) from the finger or the exclusive touch panel.

The touch panel 16 constitutes the input device 8 together with the CPU 23. Further, in the position designation receiving unit, when position designation for the taken image displayed on the display unit 5 by the user can be three-dimensionally detected, any position detection device can be used, other than the capacitance type touch panel 16. Other position detection devices, for example, an electromagnetic induction type touch panel or an optical touch panel using the infrared rays, and an image recognition type touch panel using a video camera may be used.

The recording device 19 may be, for example, a disc, such as a DVD (Digital Versatile Disc), a semiconductor memory, such as a memory card, a magnetic tape, and other removable record media, and is attached/detached to/from the imaging device 10. Further, the recording device 19 may be implemented by a semiconductor memory, a disc, an HDD or the like, which are mounted in the imaging device 10. The recording device 19 records an image signal that has undergone the signal process in the signal processing unit 7, to the record medium as image data, on the basis of an instruction from the CPU 23 (corresponding to the photographing/recording control unit).

The operation unit 24 is an operation unit disposed separately from the touch panel 16, and for example, includes various buttons, such as a shutter button and a power button, a switch, a lever, a dial, and a cross key and the like. Further, the operation unit 24 may include a user input portion that detects a predetermined user input, such as a contact sensor, an optical sensor or the like.

The EEPROM 25 stores data that should be maintained even if the power is turned off, such as a variety of information setting the corresponding relationship between the function and the distance from the finger to the touch panel 16. The program 26 stores data that is necessary to execute the program that the CPU 23 executes, the corresponding program. Further, the RAM 27 temporarily stores a program or data that is necessary as a work area when the CPU 23 performs various processes. The EEPROM 25, the program ROM 26, and the RAM 27 correspond to the storing unit 4 of FIG. 1.

### [External Configuration]

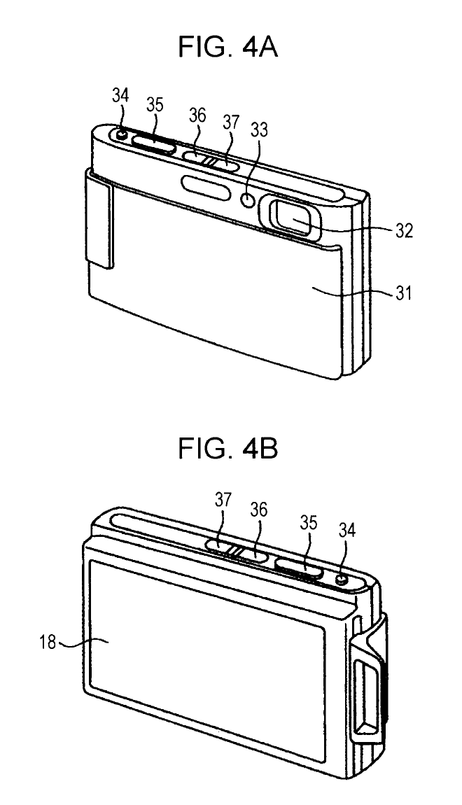

Herein, an example of the external configuration of the imaging device 10 according to the embodiment is described with reference to FIGS. 4A and 4B. FIG. 4A and FIG. 4B are front perspective view and a rear perspective view showing the imaging device 10 according to the embodiment.

As shown in FIGS. 4A and 4B, the front side of the imaging device 10 is covered with a slide type lens cover 31. A photographing lens 32 and an AF illuminator 33 constituting the lens unit 11 are disposed to be exposed when the imaging device is opened by sliding down the lens cover 31 on the front side. The AF illuminator 33 also functions as a self timer lamp. Further, the touch screen 18 is disposed on the rear side of the imaging device 10, occupying most of the rear side.

Further, a zoom lever (TELE/WIDE) 34, a shutter button 35, a reproduction button 36, and a power button 37 are disposed on the top of the imaging device 10. The zoom lever 34, shutter button 35, reproduction button 36, and power button 37 are examples of the operation unit 24 shown in FIG. 3. Further, the user can give an instruction of a photographing operation by pressing the shutter button 35, but the imaging device 10 according to the embodiment can photograph only by an input operation through the touch panel 16, such that the shutter button 35 may be removed.

Further, an operation member that is not necessary to be pressed by the user, such as a contact sensor or an optical sensor, may be installed, instead of the shutter button 35, as an operation member for giving an instruction of imaging.

This is an example of a means for stable photographing by preventing shaking due to pressing the shutter button 35 in photographing.

### [Operation of Imaging Device]

Next, the operation of the imaging device 10 having the hardware configuration described above is described.

The CPU 23 controls the parts constituting the imaging device 10 by executing the programs stored in the program ROM 26 and performs a predetermined process in response to a signal from the touch panel 16 or a signal from the operation unit 24. The operation unit 24 supplies a signal corresponding to the operation by the user to the CPU 23.

### (a) AF Control

In imaging, first, when object light travels into the imaging element 12 through the lens unit 11, the imaging element 12 images the object within the imaging range. That is, the imaging element 12 outputs an analog image signal by photoelectrically converting an optical image collected on an imaging surface by the lens unit 11. In this process, the motor driver 21 drives the actuator 20 on the basis of the control of the CPU 23. The lens unit 11 is exposed/received from/into the chassis of the imaging device 10 by the driving. Further, the diaphragm of the lens unit 11 is adjusted or the focus lens of the lens unit 11 is moved by the driving. Accordingly, the lens unit 11 is automatically focused on the object in the AF region (automatic focus control).

### (b) AE Control

Further, the timing generator 22 supplies a timing signal to the imaging element 12 on the basis of the control of the CPU 23. The exposure time of the imaging element 12 is controlled by the timing signal. The imaging element 12 performs exposure conversion by receiving the light from the object incident through the lens unit 11, by operating on the basis of the timing signal supplied from the timing generator 22. Further, an analog image signal, as an electric signal according to the amount of received light, is supplied to the analog signal processing unit 13. Accordingly, exposure of the image obtained by imaging the object is appropriately and automatically adjusted (automatic exposure control).

### (c) Signal Process

The analog signal processing unit 13 performs an analog signal process (amplification or the like) for the analog image signal sent out from the imaging element 12 on the basis of the control of the CPU 23, and supplies the image signal obtained as a result of the process to the A/D converting unit 14. The A/D converting unit 14 performs A/C conversion on the analog image signal from the analog signal processing unit 13 on the basis of the control of the CPU 23, and supplies digital image data obtained as a result of the conversion to the digital signal processing unit 15. The digital signal processing unit 15 performs necessary digital signal process, such as noise removal, white balance adjustment, color correction, edge reinforcement, and gamma correction, for the digital image signal from the A/D converting unit 14 on the basis of the control of the CPU 23, and supplies and displays the signal to the liquid crystal panel 17. The image signal output from the digital signal processing unit 15 is supplied to the CPU 23.

### (d) Compression Recording Process

Further, the digital signal processing unit 15 compresses the digital image signal from the A/D converting unit 14 in a predetermined type of compressing coding, for example, JPEG (Joint Photographic Experts Group) type. Further, as a result, the compressed and obtained digital image signal is supplied to the recording device 19 recorded.

### (e) Reproduction Process

Further, the digital signal processing unit 15 extends the compressed image data recorded in the recording device 19 and supplies and displays the image data obtained as the result of extension to the liquid crystal panel 17.

### (f) Display Process of Live View Image.

The digital signal processing unit 15 supplies a motion image data from the A/C converting unit 14 to the liquid crystal panel 17, and accordingly, a live vice image (motion image) obtained by imaging the object within the imaging range is displayed on the liquid crystal panel 17. The live view image is for the user to visually recognize the imaging range or angle and the state of the object the like to take a desired still image. Therefore, the image quality of the live view image is not obtained like the still image (photograph) recorded in the recording device 19. Accordingly, a motion image of which the data density is reduced and the signal process is simplified is used for the live view image, in consideration of a rapid and easy imaging process.

In addition, the digital signal processing unit 15 generates an image of the AF box (multi AF box, spot AF box or the like) used for focus control on the basis of the control of the CPU 23 and displays the AF box on the liquid crystal panel 17.

As described above, in the imaging device 10 according to the embodiment, the AF box is set on the image taken by the imaging element 12 and the focus is controlled on the basis of the image inside the AF box. In the AF function, the AF box can be set at any position on the image displayed on the liquid crystal panel 17. Further, for example, it is possible to control the position or the size only by operating through the liquid crystal panel 17 and the touch panel 16 having a common configuration.

As described above, when the motion image (live view image) taken by the imaging unit 6 is displayed on the liquid crystal panel 17, the user determines the camera angle of the imaging device 10 toward a desired object and takes an image. In the photographing, in general, the user gives an instruction of imaging to the imaging device 10 by performing a predetermined operation (for example, press the shutter button) through the operation unit 24. A release signal is supplied from the operation unit 24 to the CPU 23 in response to the operation of the user. When the release signal is supplied to the CPU 23, the CPU 23 controls the digital signal processing unit 15, compresses the image data supplied to the digital signal processing unit 15 from the A/D converting unit 14, and records the compressed image data to the recording device 19. Hereafter, this process is referred to as “photographing/recording process”. In the operation of the imaging device 10 described above, the signal process of the signal processing unit 7 (c), and the image data compression process of the digital signal processing unit 15 and the recording process of the recording device 19 (d) correspond to the “photographing/recording process” of the embodiment.

### [Imaging Method]

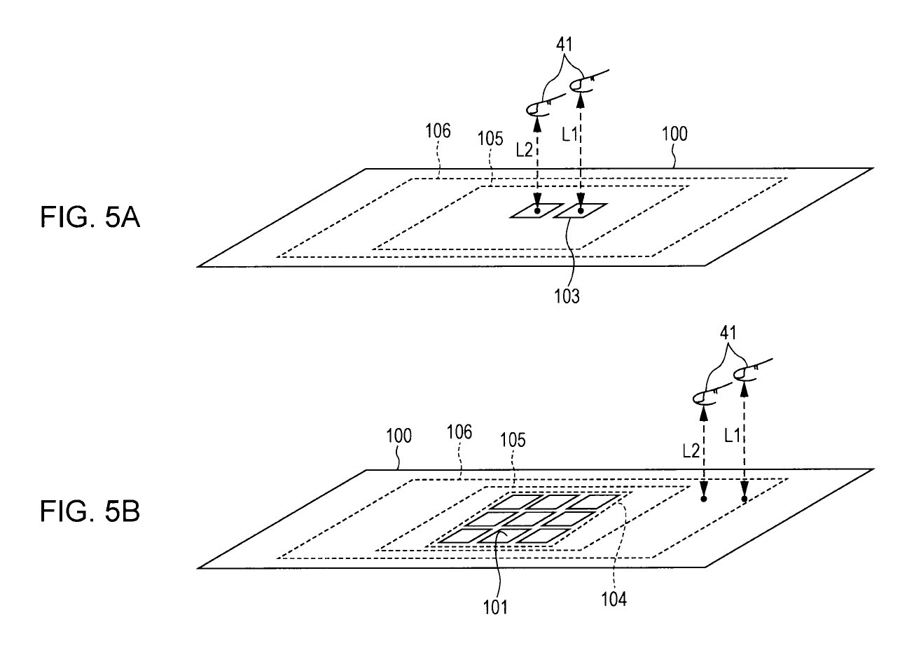

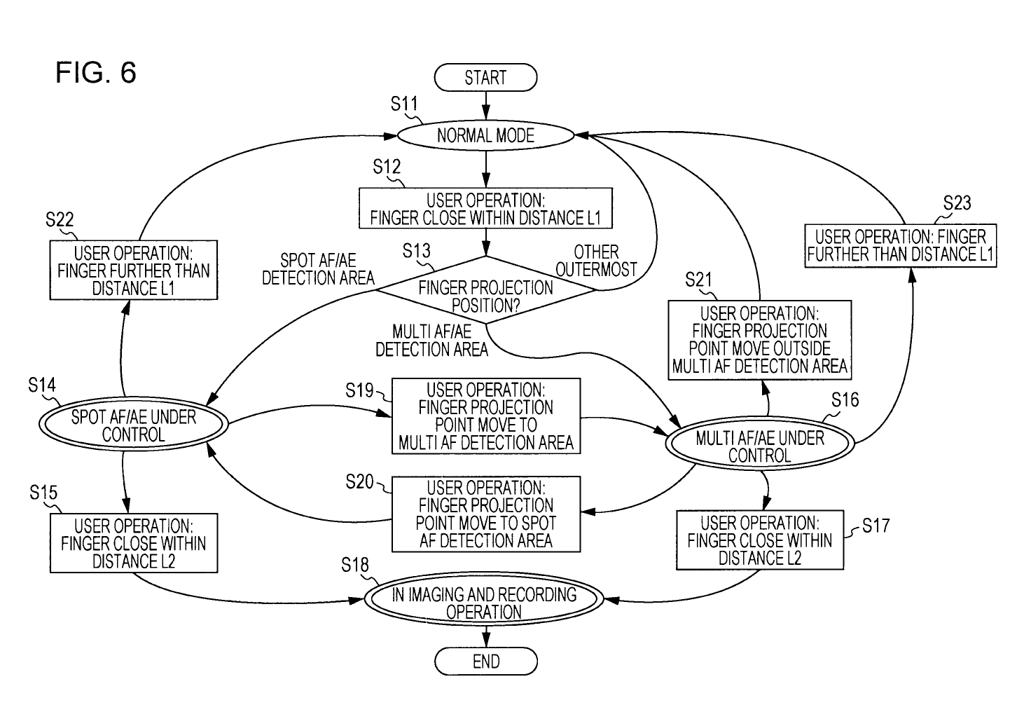

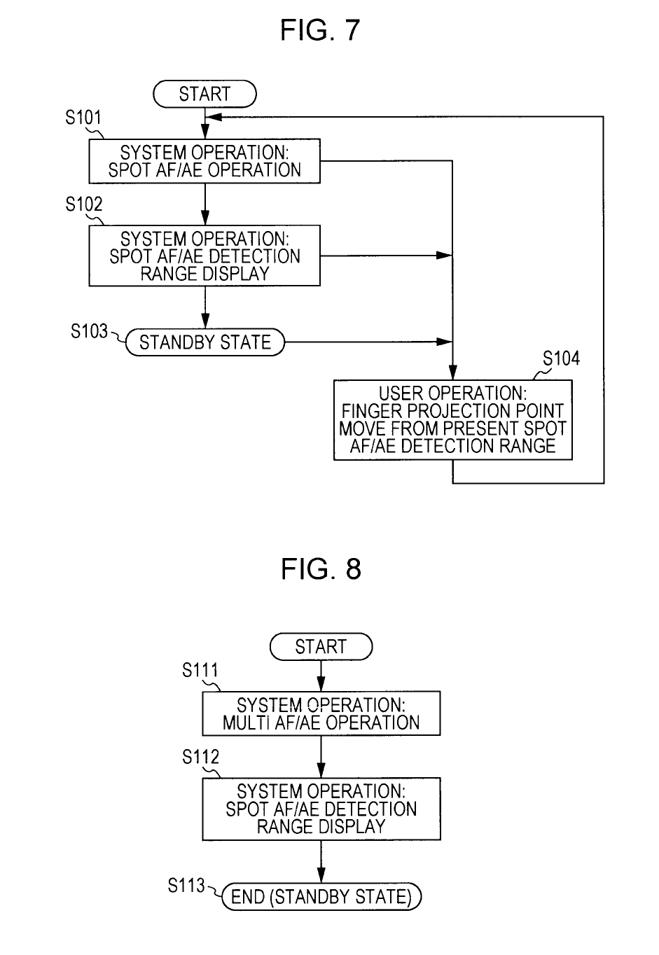

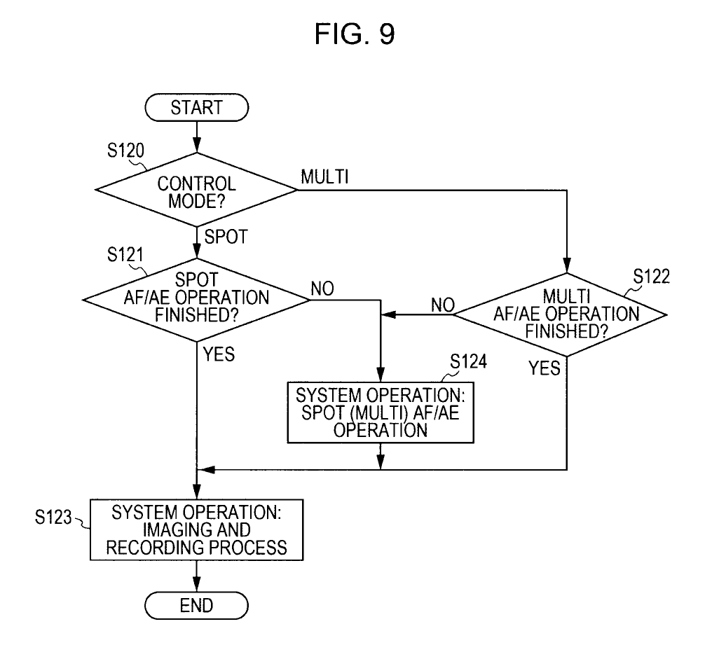

Next, an imaging method of the imaging device 10 is described in detail with reference to FIG. 5, FIG. 6 and FIGS. 7 to 9. FIG. 5A and FIG. 5B are illustrative diagrams showing an example of the input operation in photographing in the imaging device 10 and FIG. 6 is a flowchart showing an example of an imaging operation of the imaging device 10. FIG. 7 is a flowchart showing an example of a process of the control unit 1 in step S14 (in spot AF/AE control) shown in FIG. 6. FIG. 8 is a flowchart showing an example of a process of the control unit 1 in step S15 (in multi AF/AE control) shown in FIG. 6. FIG. 9 is a flowchart showing an example of a process of the control unit 1 in step S16 (in photographing/recording operation control) shown in FIG. 6.

Further, in FIG. 5A and FIG. 5B, although two fingers 41 are within a range perpendicular to the inside of different spot AF detection boxes 103, respectively, for the convenience of description, two fingers 41 may be moved within the range perpendicular to the inside of the same spot AF detection box 103. In the following description, the spot AF detection box and the spot AE detection box are referred to as a spot AF/AE detection box 103 while the multi AF detection box and the multi AE detection box are referred to as a multi AF/AE detection box 104.

The photographing method in the flowchart of FIG. 6 is described. First, a user moves a finger 41 above the touch panel 16 of the imaging device 10 and approaches the finger to the surface, in a normal mode (step S11). Accordingly, the main control unit 2e (see FIG. 3) of the control unit 1 detects the fact when the distance between the finger 41 and the touch panel 16 becomes within L1 (step S12) and determines the coordinates vertically projected onto the touch panel 16 from the position of the finger 41 as the xy coordinates designated by the user.

In this process, the mode setting unit 2a determined whether the detected xy coordinates is within a range perpendicular to the inside of the spot AF detection area 105 or within a range perpendicular to the inside of the multi AF detection area 106 (step S13). As in FIG. 5A, when the detected xy coordinates are within the region perpendicular to the spot AF detection area 105, the mode setting unit 2a performs spot AF/AE control (step S14). Meanwhile, as in FIG. 5B, when the detected xy coordinates are within the region perpendicular to the multi AF detection area 106, the mode setting unit 2a performs AF/AE control (step S16). Further, the detected xy coordinates are in another region, for example outside the multi AF detection area 106, the process proceeds to step S11 that is a normal mode.

The spot AF/AE control in step S14 (see FIG. 6) is described in detail with reference to the flowchart of FIG. 7. Right after proceeding to step S14, the main control unit 2e (imaging control unit) and the AF region setting unit 2b (or AE region setting unit 2c) performs a spot AF/AE operation for a narrow region around the detected coordinates (step S101). Further, when the spot AF/AE becomes in a lock state (a state in which focusing/exposing process is finished), the display control unit 2d displays the spot AF/AE detection box 103 representing that the lock state has been implemented, on the liquid display panel 17 by controlling the digital signal processing unit 15 (step S102). Thereafter, the process proceeds to a standby state (step S103).

In any one of the processes in step S101, step S102, and step S103, it is monitored whether the user moves the finger 41 outside the space perpendicular to the region of the present spot AF/AE detection box 103 (step S104). When the finger 41 is moved outside the space perpendicular to the region of the present spot AF/AE detection box 103, the main control unit 2e determines that the coordinates vertically projected onto the touch panel 16 from the position of the finger 41 after the movement as the xy coordinates that the user re-designates. Further, the series of operation in the spot AF/AE control is performed again for the narrow region around the same coordinates.

In step S14 that performs the spot AF/AE control, it is assumed that the user further approaches the finger 41 to the touch panel 16 and the distance becomes within L2 (shorter than L1) (step S15). In this case, the main control unit 2e proceeds to the step of photographing/recording operation (step S18). The process returns, for example, to the normal mode of step S11, after the photographing/recording operation is finished.

The multi AF/AE control in step S16 (see FIG. 6) is described in detail with reference to the flowchart of FIG. 8. Right after proceeding to step S16, the main control unit 2e (imaging control unit) and the AF region setting unit 2b (or AE region setting unit 2c) performs a multi AF/AE operation around the center of the screen 100 (step S111). Further, when the multi AF/AE becomes in a lock state (a state in which focusing/exposing process is finished), the display control unit 2d displays a plurality of multi AF/AE detection boxes 104 representing that the lock state has been implemented, on the liquid display panel 17 by controlling the digital signal processing unit 15 (step S112). Thereafter, the process proceeds to a standby state (step S113).

In step S16 that performs the multi AF/AE control, it is assumed that the user further approaches the finger 41 to the touch panel 16 and the distance becomes within L2 (shorter than L1) (step S17). In this case, the main control unit 2e proceeds to the step of photographing/recording operation (step S18). The process returns, for example, to the normal mode of step 11, after the photographing/recording operation is finished.

In step S14 that performs the spot AF/AE control, it is assumed that the user moves the finger 41 outside the space perpendicular to the spot AF detection area 105, that is, inside the space perpendicular to the multi AF detection area 106 (step S19). In this case, the mode setting unit 2a stops the spot AF/AE operation or unlocks the spot AF/AE, and proceeds to step S16 that performs the multi AF/AE control.

On the contrary, in step S16 that performs the multi AF/AE control, it is assumed that the user moves the finger 41 inside the space perpendicular to the multi AF detection area 106, that is, inside the space perpendicular to the spot AF detection area 105 (step S20).

In this case, the mode setting unit 2a stops the multi AF/AE operation or unlocks the multi AF/AE, and proceeds to step S14 that performs the spot AF/AE control.

Further, in step S16, it is assumed that the user moves the finger 41 outside the space perpendicular to the multi AF detection area 106 (step S21). In this case, the mode setting unit 2a stops the multi AF/AE operation or unlocks the multi AF/AE, and proceeds to step S11 that is the normal mode.

In the step S14 that performs the spot AF/AE control, it is assumed that the user moves the finger 41 further than the distance L1 with respect to touch panel 16. In this case, the mode setting unit 2a stops the spot AF/AE operation or unlocks the spot AF/AE, and proceeds to step S11 that is the normal mode (step S22).

Similarly, in the step S16 that performs the multi AF/AE control, it is assumed that the user moves the finger 41 further than the distance L1 with respect to touch panel 16. In this case, the mode setting unit 2a stops the multi AF/AE operation or unlocks the multi AF/AE, and proceeds to step S11 that is the normal mode (step S23).

Next, the photographing/recording operation in step S18 (see FIG. 6) is described in detail with reference to the flowchart of FIG. 9.

First, when the process proceeds to the photographing/recording state in step S18, the main control unit 2e ascertains the control mode of the step before the process proceeds to step S18 (step S120). In this case, when the control mode is the spot AF/AE control of step S14, it is ascertained whether locking of the spot AF/AE is finished (step S121). When the locking of the spot AF/AE is finished, the main control unit 2e performs a photographing/recording process (step S123). Meanwhile, when the locking of the spot AF/AE is not finished, the main control unit 2e and the AF region setting unit 2b (or the AE region setting unit 2c) performs a spot AF/AE operation (step S124).

Further, the process proceeds to step S123 and the photographing/recording process is performed after the locking of the spot AF/AE is finished.

Further, in this case, when the control mode is the multi AF/AE control of step S16, it is ascertained whether locking of the multi AF/AE is finished (step S122). When the locking of the multi AF/AE is finished, the main control unit 2e performs a photographing/recording process (step S123). Meanwhile, when the locking of the multi AF/AE is not finished, the main control unit 2e and the AF region setting unit 2b (or the AE region setting unit 2c) performs the multi AF/AE operation (step S124), and proceeds to step S123 and perform the photographing/recording process after the locking of the multi AF/AE is finished.

According to the first embodiment described above, it is possible to give an instruction in accordance with the distance between the detection surface of the touch panel and the user's finger, from the process of the optical system of the step before photographing to the photographing/recording process of the camera, which is the spot AF/AE or the multi AF/AE, in a camera or the like. Therefore, as compared with using a photo reflector or an optical sensor in the related art, the range where a finger can be detected is not limited and is not limited to a narrow region where a specific icon is displayed on the touch screen. Therefore, since it is possible to perform the processes from the process of the optical system of the step before photographing of the camera to the photographing/recording process by performing wide and non-contact operation on the touch screen, it is possible to provide an input device that maintains intuitive operability and reduces shaking in photographing.

In the embodiment, a user can give an instruction of two connected functions (operation) by performing a seamless operation, by setting the functions (operation) in connection to the distance from the detection surface of the touch panel to the finger.

Further, in the embodiment, although an example of performing two connected functions was described, for example, three connected functions may be performed by a seamless operation, by setting three connected functions in connection with different three distances, respectively.

### 2. Second Embodiment

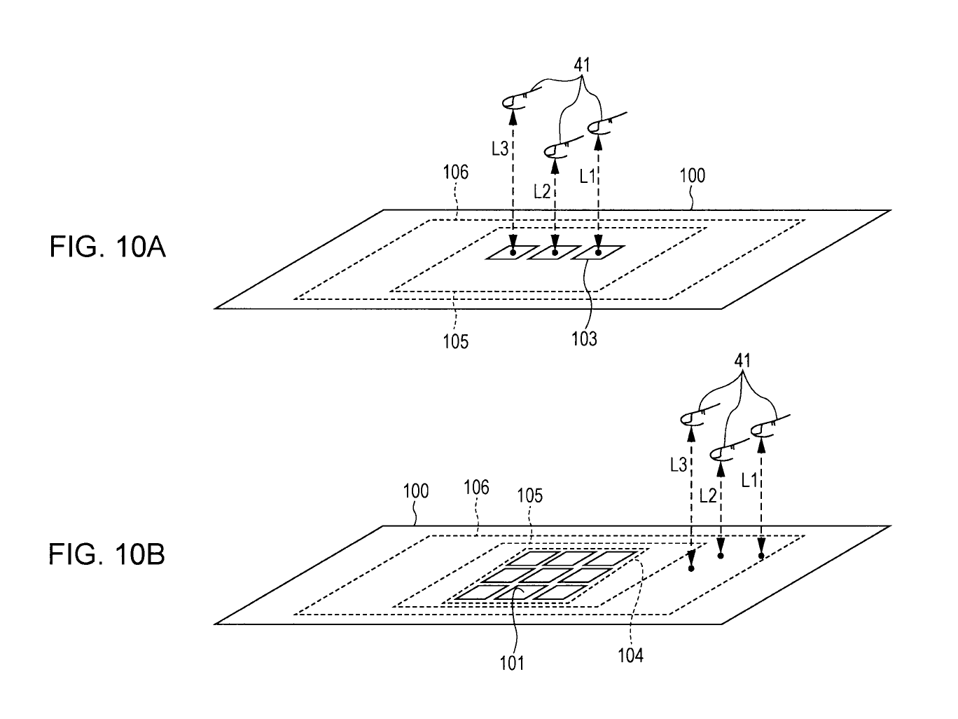

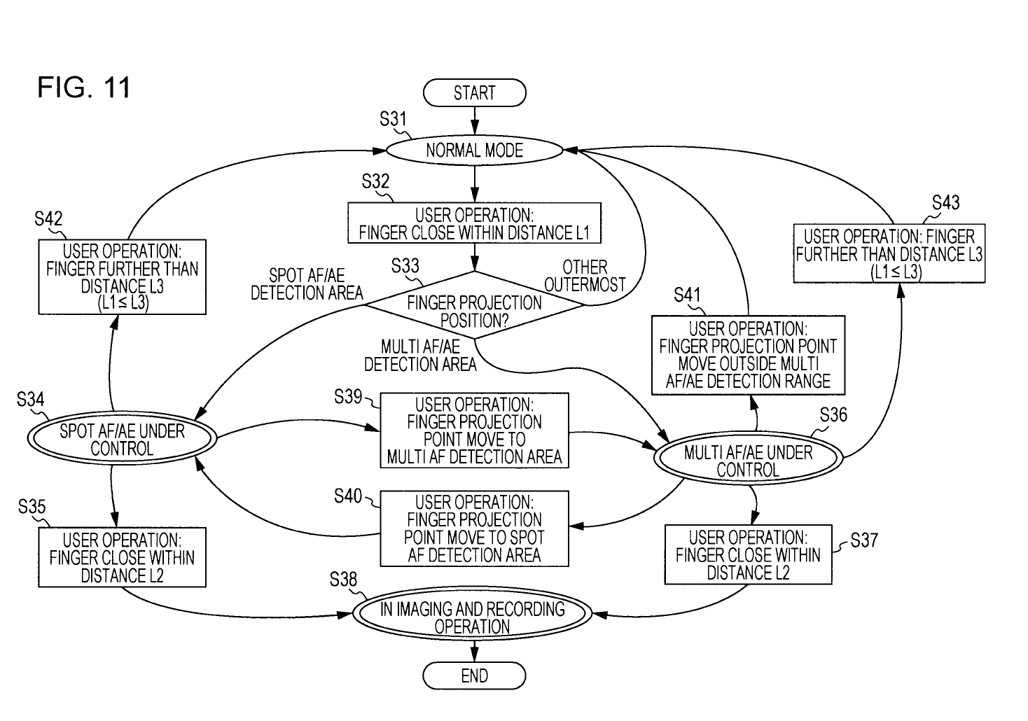

Next, an imaging device and an imaging method according to a second embodiment are described with reference to FIG. 10 and FIG. 11. The first embodiment is an example of setting two distances in connection with the distance between the finger 41 and the touch panel 16 of the imaging device 10, while the second embodiment is an example of setting three distances in connection with the distance between the finger 41 and the touch panel 16. In the second embodiment, it is assumed that the object for an input operation is the imaging device 10 according to the first embodiment, such that the difference between the first embodiment and the second embodiment, that is, the features of the second embodiment are mainly described hereafter.

FIG. 10A and FIG. 10B are illustrative view showing an input operation in photographing in the imaging device according to the embodiment and FIG. 11 is a flowchart showing an example of an imaging operation in the imaging device according to the embodiment. Further, in FIG. 10A and FIG. 10B, it is described that three fingers 41 representing an operation of one user is positioned in a region perpendicular to different spot AF detection boxes 103, respectively, for the convenience of description. However, three fingers 41 may be moved inside a region perpendicular to the region of the same spot AF detection box 103.

The photographing method in the flowchart of FIG. 11 is described. The processes in step S31 to S41 shown in FIG. 11 are the same as the processes of step S11 to step S21 (see FIG. 6) illustrated in the first embodiment, such that the description is not provided.

In the step S34 that performs the spot AF/AE control, it is assumed that the user moves the finger 41 further than the distance L3 with respect to touch panel 16. In this case, the mode setting unit 2a stops the spot AF/AE operation or unlocks the spot AF/AE, and proceeds to step S31 that is the normal mode (step S42).

Similarly, in the step S43 that performs the multi AF/AE control, it is assumed that the user moves the finger 41 further than the distance L3 with respect to touch panel 16. In this case, the mode setting unit 2a stops the multi AF/AE operation or unlocks the multi AF/AE, and proceeds to step S31 that is the normal mode (step S43).

In the second embodiment described above, the distance between the user's fingers 41 and the touch panel 16 is set in L3≧L1. That is, in order to proceed to the step of the spot AF/AE control, the distance L3 for returning to the normal mode that removes the spot AF/AE control is set larger than the distance L1 between the user's fingers 41 and the touch panel 16 and hysteresis is provided between the distances. This is the same for the multi AF/AE control.

In the first embodiment, proceeding between the step of the spot AF/AE control and the normal mode may occur at a place that the user does not intend, by shaking of the user's fingers 41 when proceeding to the step of the spot AF/AE control. On the contrary, in the second embodiment, it is possible to prevent the mis-operation by implementing an operational instruction considering the hysteresis shown in FIG. 10. This is the same for the multi AF/AE control.

Other than that described above, the second embodiment can give two connected functions (operations) with a seamless operation, by setting the functions (operation) in connection with the distance from the detection surface to the fingers, including the operation and effect of the first embodiment.

### 3. Third Embodiment

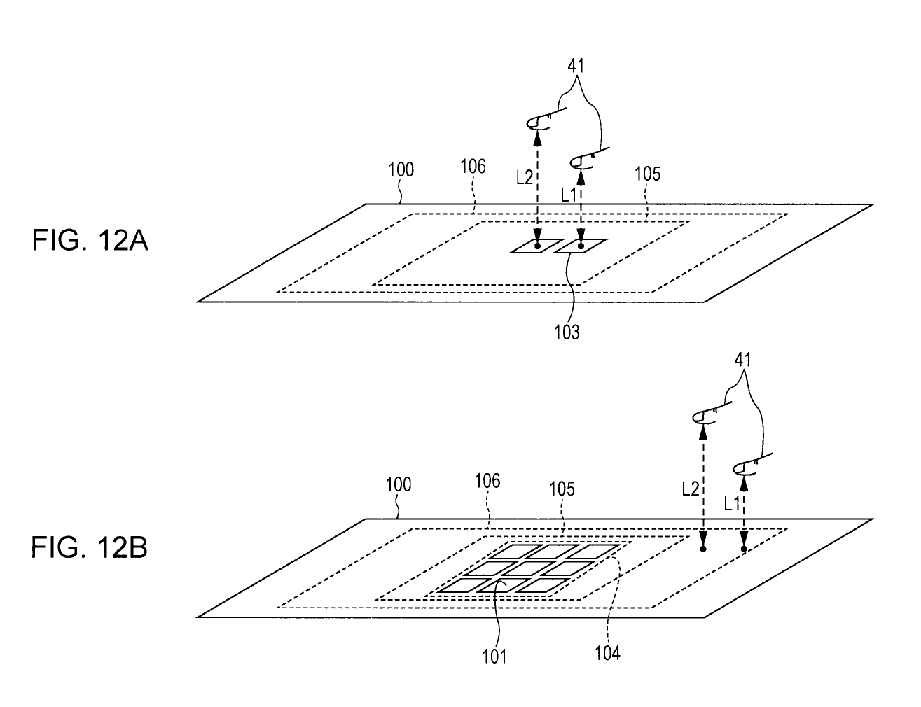

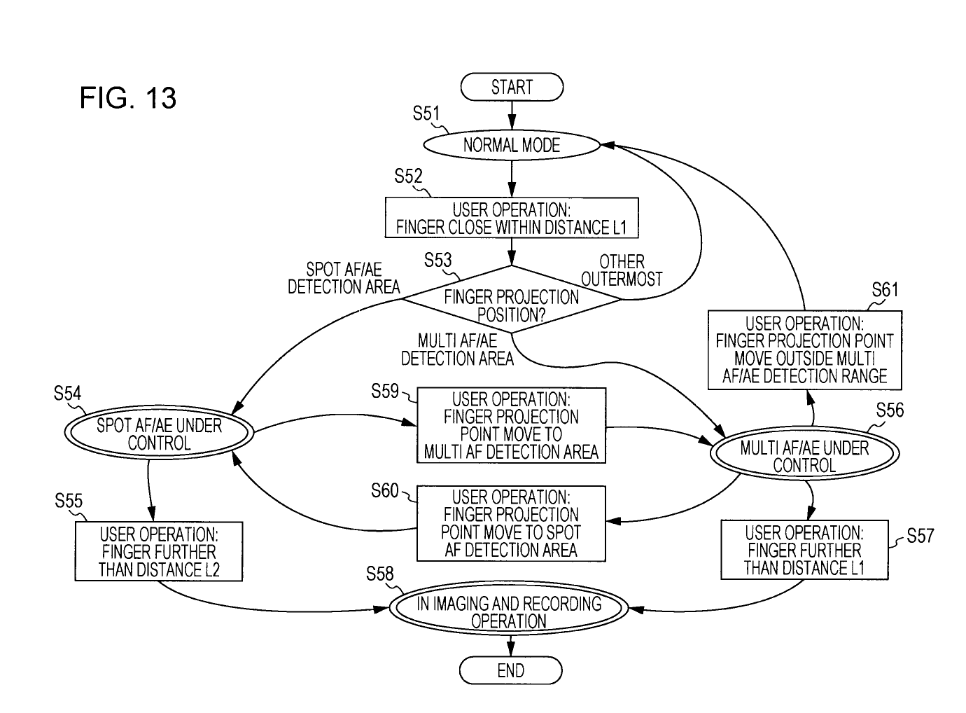

Next, an imaging device and an imaging method according to a third embodiment are described with reference to FIG. 12 and FIG. 13. In the first and second embodiments, the user approaches the fingers to the touch panel to give an instruction of the photographing/recording process. On the other hand, the third embodiment is an example of performing the photographing/recording process, making an action that a user approaches a finger to the touch panel and moves the finger away from the touch panel, as a trigger. In the third embodiment, it is assumed that the object for an input operation is the imaging device 10 according to the first embodiment, such that the difference between the first embodiment and the third embodiment, that is, the features of the third embodiments are mainly described hereafter.

FIG. 12A and FIG. 12B are illustrative view showing an input operation in photographing in the imaging device according to the embodiment and FIG. 13 is a flowchart showing an example of an imaging operation in the imaging device according to the embodiment. Further, in FIG. 12A and FIG. 12B, it is described that two fingers 41 representing an operation of one user is positioned in a region of different spot AF detection boxes 103, respectively, for the convenience of description. However, two fingers 41 may be moved inside a region perpendicular to the region of the same spot AF detection box 103.

The photographing method in the flowchart of FIG. 13 is described. The processes of steps S51, S53, S54, S56, S58, and S59 to S61 shown in FIG. 13 are the same as the processes of steps S11, S13, S14, S16, S18, and S19 to S21 (see FIG. 6) illustrate in the first embodiment, such that the description is not provided.

First, a user moves a finger 41 above the touch panel 16 of the imaging device 10 and approaches the finger to the surface, in a common mode (step S51). Accordingly, the main control unit 2e (see FIG. 3) of the control unit 1 detects the fact when the distance between the finger 41 and the touch panel 16 becomes within L1 (step S52) a determines the coordinates obtained by vertically projecting the position of the finger 41 onto the touch panel 16 as the xy coordinates designated by the user.

In this process, the mode setting unit 2a determined whether the detected xy coordinates is within a range perpendicular to the inside of the spot AF detection area 105 or within a range perpendicular to the inside of the multi AF detection area 106 (step S53). As in FIG. 12A, when the detected xy coordinates is within the region perpendicular to the spot AF detection area 105, the mode setting unit 2a controls spot AF/AE control (step S54). Meanwhile, as in FIG. 12B, when the detected xy coordinates are within the region perpendicular to the multi AF detection area 106, the mode setting unit 2a performs AF/AE control (step S56). Further, the detected xy coordinates are in another region, for example outside the multi AF detection area 106, the process proceeds to step S51 that is a normal mode.

In step S54 that performs the spot AF/AE control, it is assumed that the user moves the finger 41 away from the touch panel 16 and the distance becomes L2 (longer than L1) or longer (step S55). In this case, the main control unit 2e proceeds to the step of photographing/recording operation (step S58). The process returns, for example, to the normal mode of step S51, after the photographing/recording operation is finished. Further, in step S54, a process corresponding to steps S22 and S42 in the first and second embodiments does not exist.

Meanwhile, in step S56 that performs the multi AF/AE control, it is assumed that the user moves the finger 41 away from the touch panel 16 and the distance becomes L2 (longer than L1) or longer (step S57). In this case, the main control unit 2e proceeds to the step of photographing/recording operation (step S58). The process returns, for example, to the normal mode of step S51, after the photographing/recording operation is finished. Further, in step S57, a process corresponding to steps S23 and S43 in the first and second embodiments does not exist.

In the third embodiment described above, the photographing/recording process is performed by a trigger, which is an action that the user approaches the finger 41 to the touch panel 16 and moves the finger 41 away from the touch panel 16 in order to proceed to the step of the spot AF/AE control or the multi AF/AE control. In the first and second embodiment, the imaging device 10 may be physically shaken in the photographing/recording process due to contact of the finger 41 to the touch panel 16 by mistake when the user approaches the finger 41 to the touch panel 16 to give an instruction of the photographing/recording process. On the contrary, in the second embodiment, it is possible to prevent the mis-operation by implementing an operational instruction that uses the action of moving the finger 41 away as a trigger.

Other than that described above, the third embodiment can give two connected functions (operations) with a seamless operation, by setting the functions (operation) in connection with the distance from the detection surface of the touch panel to the fingers, including the operation and effect of the first embodiment.

Three embodiments for performing automatic focus scanning or automatic exposure adjustment, the capturing operation and the like without being influenced by shaking, using wide and non-contact user's operations, by the imaging device equipped with a capacitance type touch panel were described above. Next, an embodiment of applying the imaging device having the functional configuration is also introduced.

### 4. Fourth Embodiment

An imaging device is usually provided with reproduction function in order for a user to see the still image data recorded by the photographing/recording process. One of typical modes of still image reproduction functions is a one sheet of image reproduction mode, which is a mode that enlarges and displays one of the still image data recorded in the recording device, on the display unit.

When there is a plurality of still image data, the user gives an instruction to the imaging device through the operation unit and the imaging unit performs a renewal process and re-display on the display unit at each time in response to the instruction. When a plurality of still image data is stored in the recording device, the order is specifically determined by the compression decoding type, such as JPEG and the order of re-display of the images by an operation instruction from the user follows the above order. Hereafter, the operation of re-displaying the images in the normal direction is referred to as “image transmission” and the operation of reversely re-displaying the images is referred to as “image return”. Both the image transmission and the image return generally renew one by one ever time the user gives one operation instruction. However, when the recording device has a large capacity and the number of recorded still image data is largely increased, in an operation type that can perform the image transmission or the image return one by one in one operation of the user, it takes time and effort to be managed to access desired still image data, thereby increasing inconvenience.

Therefore, it is important to provide an operation type that can continuously give instructions while implementing the image transmission and the image return at a high speed, not a sporadic action, such as “pressing” of the operation unit by the user, in the imaging device. Further, it is preferable that the operation type can change the speed of the image transmission and the image return. Hereafter, an embodiment (the fourth embodiment) that applies an imaging device equipped with a capacitance type touch panel, as a functional configuration, and continuously gives instructions of the image transmission and the image return, and changes the speed is described.

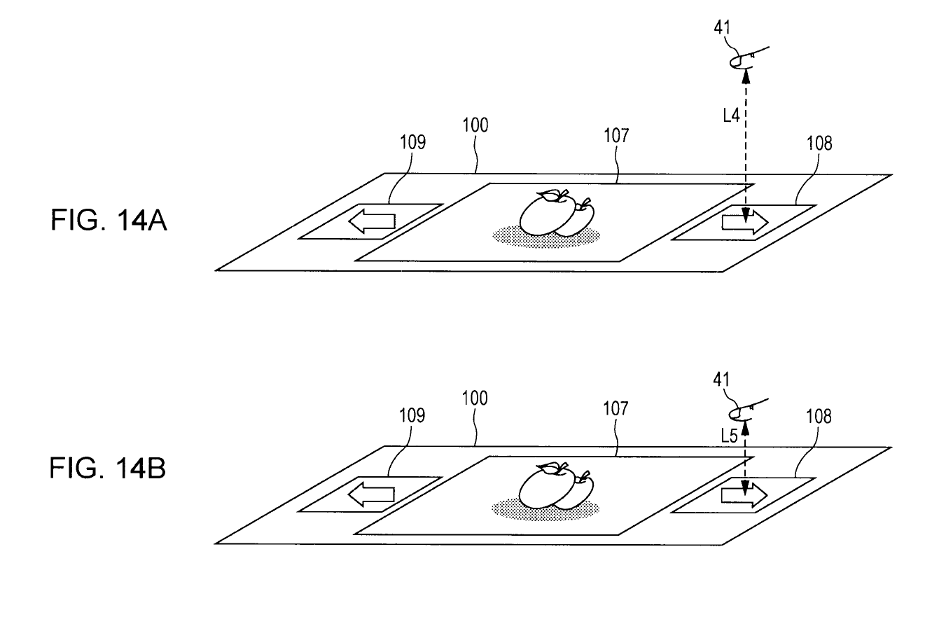

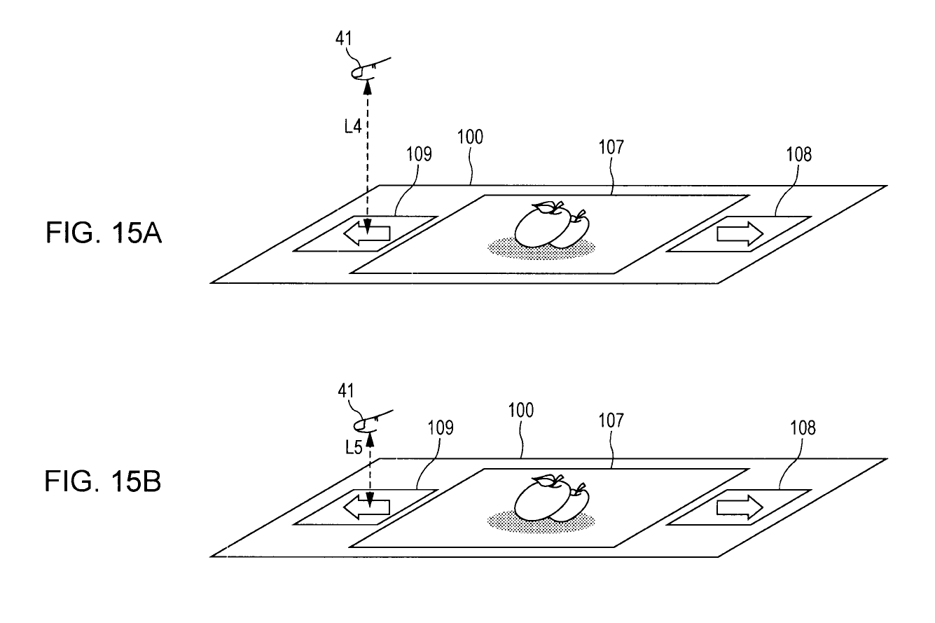

A hardware configuration according to the fourth embodiment is described with reference to FIG. 1 and FIG. 3. Further, an operational example of the image transmission for reproduction in the imaging device 10 according to the embodiment is shown in FIGS. 14A and 14B, and an image diagram showing an operational example of the image return is shown in FIG. 15A and FIG. 15B. When a user intends to user a still image reproduction function, the control unit 1 sets the mode of the imaging device 10 to a one sheet image reproduction mode, using the mode setting unit 2a. In the one sheet image reproduction mode, the digital signal processing unit 15 reads out the compressed image data recorded in the recording device 19, into the RAM 27, on the basis of the control of the CPU 23 (main control unit 2e). Further, an extension process is performed on the RAM 27, the image data obtained as a result of the extension process is supplied to the liquid crystal panel 17, which is a display unit, and displayed inside a still image data display box 107 on the liquid crystal panel 17. In this case, an image transmission symbol 108 and an image return symbol 109 (softkey) are displayed in parallel with the still image data display box 107 on the screen 100 of the liquid crystal panel 17, on the basis of the control of the display control unit 2d.

Next, a detailed embodiment of the image transmission is described. First, it is assumed that the user approaches the finger 41 to a space perpendicular to the image transmission symbol 108. In this case, as shown in FIG. 14A, the main control unit 2e detects the coordinates vertically projected onto the touch panel 16 from the position of the finger 41 when the distance between the finger 41 and the touch panel 16 becomes shorter than a predetermined distance L4. The main control unit 2e determines that the user gives an instruction of image transmission and performs an image transmission process by controlling the digital signal processing unit 15. That is, the image transmission process is performed on the basis of the control of the CPU 23 and the image data in the still image data display box 107 is renewed and re-displayed.

When the user continues the motion of approaching the finger 41 in the space perpendicular to the image transmission symbol 108, the main control unit 2e takes it as that the user continuously gives instructions of image transmission and continuously performs the image transmission process. When the finger 41 is held in the space perpendicular to the image transmission symbol 108 and the distance from the touch panel 16 is constant, the speed of the image transmission performed by the main control unit 2e is uniform and the display inside the still image data display box 107 is continuously renewed at a constant speed.

When the user moves the finger 41 further than the distance L4 in the space perpendicular to the image transmission symbol 108, the main control unit 2e stops the image transmission process. Still image data read out when the image transmission is finished is activated in the still image data display box 107. On the contrary, as shown in FIG. 14B, when the user approaches the finger 41 to the touch panel 16 to a distance L5 (<L4), the main control unit 2e continuously performs the image transmission process at a speed higher than the state shown in FIG. 12A. As a result, display in the still image data display box 107 is continuously renewed at a higher constant speed.

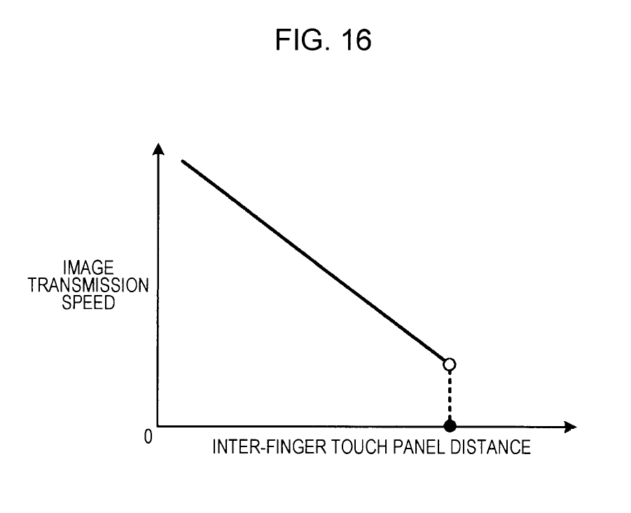

FIG. 16 is a characteristic diagram showing an example of the relationship between image transmission continuation process speed by the imaging device 10 and the distance between the finger 41 and the touch panel 16. As long as the distance between the finger 41 and the touch panel 16 is shorter than L4, in the space perpendicular to the image transmission symbol 108, the main control unit 2e continuously performs the image transmission process. On the contrary, when the finger 41 is outside the space perpendicular to the image transmission symbol 108, the main control unit 2e stops the image transmission process. In this case, the still image data read out when the image transmission is finished is activated in the still image data display box 107.

Next, a detailed embodiment of the image return is described. First, it is assumed that the user approaches the finger 41 to a space perpendicular to the image return symbol 109. In this case, as shown in FIG. 15A, the main control unit 2e detects the coordinates vertically projected onto the touch panel 16 from the position of the finger 41 when the distance between the finger 41 and the touch panel 16 becomes shorter than a predetermined distance L4. The main control unit 2e determines that the user gives an instruction of image return and performs an image return process by controlling the digital signal processing unit 15. That is, the image return process is performed on the basis of the control of the CPU 23 and the image data in the still image data display box 107 is renewed and re-displayed.

When the user continues the motion of approaching the finer 41 in the space perpendicular to the image return symbol 109, the main control unit 2e takes it as that the user continuously gives instructions of image return and continuously performs the image return process. When the finger 41 is held in the space perpendicular to the image return symbol 109 and the distance from the touch panel 16 is constant, the speed of the image return performed by the main control unit 2e is uniform and the display inside the still image data display box 107 is continuously renewed at a constant speed.

When the user moves the finger 41 further than the distance L4 in the space perpendicular to the image return symbol 109, the main control unit 2e stops the image return process. Still image data read out when the image return is finished is activated in the still image data display box 107. On the contrary, as shown in FIG. 15B, when the user approaches the finger 41 to the touch panel 16 to a distance L5 (<L4), the main control unit 2e continuously performs the image return process at a speed higher than the state shown in FIG. 15A. As a result, display in the still image data display box 107 is continuously renewed at a higher constant speed.

The relationship between the image return continuation process speed by the imaging device 10 and the distance between the finger 41 and the touch panel 16 is shown, for example, in the characteristic diagram shown in FIG. 16, in the same as in the image transmission. As long as the distance between the finger 41 and the touch panel 16 is shorter than L4, in the space perpendicular to the image return symbol 109, the main control unit 2e continuously performs the image return process. On the contrary, when the finger 41 is outside the space perpendicular to the image return symbol 109, the main control unit 2e stops the image return process. In this case, the still image data read out when the image return is finished is activated in the still image data display box 107.

It is possible to continuously and variably perform the image transmission and the image return, for the one sheet of image reproduction mode of the imaging device by the fourth embodiment described above. Therefore, it is possible to secure operability that makes it possible to efficiently access desire image data even if a large amount of still image data exists in large-capacity recording device.

Other than that described above, the fourth embodiment allows a user to give two connected functions (operations) with a seamless operation, by setting the functions (operation) in connection with the distance from the detection surface of the touch panel to the fingers, including the operation and effect of the first embodiment.

Further, as an application embodiment, it is possible to provide an input device that makes it possible to efficiently access desired image data by allowing switching of continuous and speed-variable reproducing for one sheet of image reproduction mode, even in a large-capacity recording device. Further, not being limited to the one sheet of image reproduction mode, an operation instruction of image transmission or image return of still image data for a plurality of sheets, of reproducing video data and adjusting the speed may be applied. Further, the user can give an instruction of performing two or more connected functions (operations) for an object-to-control, by using the seamless operation method of the embodiment.

Further, although the series of processes of the embodiments described above can be performed by software, but may be performed by hardware. Further, the imaging device (input device) may be provided with a recording medium (for example, the recording device 19) where a program code of the software for implementing the functions of the embodiments described above is recorded. Further, it is possible to implement a desired function by reading out a program code stored in a recording medium with a computer (or a control device, such as a CPU) of the device.

In this case, as the recording medium for supplying the program code, for example, a flexible disc, a hard disc, an optical disc, an optical magnetic disc, and CD-ROM, a CD-R, a magnetic tape, a nonvolatile memory card, a ROM and the like may be used.

Further, the functions of the embodiment described above are implemented by executing the program code that the computer reads out. In addition, an OS or the like, which is executed on the computer, performs some of or the entire actual processes, on the basis of an instruction from the program code. When the functions of the embodiments described above by the process is also included.

Further, in this specification, the process steps describing processes in time series includes processes that are performed in parallel or separately (for example, parallel processes or processes by an object), even if the processes are not performed in time series, in addition to the processes that are performed in time series in accordance with the described order.

In the above, the present disclosure is not limited to the embodiment described above, various modified examples and applications may be implemented without departing from the scope of the present disclosure, which is described in claims.

The present disclosure contains subject matter related to that disclosed in Japanese Priority Patent Application JP 2010-250791 filed in the Japan Patent Office on Nov. 9, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An input device comprising:
a detector that
detects a presence of an object that is within a first predetermined distance of a detection surface, and
detects when the object is within a second predetermined distance of the detection surface; and
a controller that executes a first processing operation when the detector detects the object being within the first predetermined distance, and subsequently executes a related second processing operation when the detector detects the object being within the second predetermined distance.

2. The device of claim 1, wherein
the controller uses a setting established by the first processing operation when executing the second processing operation.

3. The device of claim 1, wherein
said detector and controller are disposed in a portable imaging device.

4. The device of claim 3, wherein
said portable imaging device being at least one of a video recorder, digital camera, and a tablet computer.

5. The device of claim 1, further comprising:
an image sensor; and
a display that displays a live image during said first processing operation, wherein
said second processing operation includes capturing and recording an image.

6. The device of claim 5, wherein
the first processing operation includes using multi Auto Focus over a plurality of auto focus regions.

7. The device of claim 1, wherein
when said detector detects the object within the first predetermined distance, the detector also detects a vertically projected position of the object with respect to the detection surface, and
said controller determines an operational mode of said device based on said vertically projected position.

8. The device of claim 7, wherein
when said vertically projected position falls within a first area on said detection surface said controller places said device into a spot Auto Focus/Auto Exposure mode.

9. The device of claim 8, wherein
when said vertically projected position is detected as being moved to a second area on said detection surface, said controller places said device into a multi Auto Focus mode.

10. The device of claim 9, wherein
when said vertically projected position is subsequently detected as being returned to the first area on said detection surface, said controller returns said device into the spot Auto Focus/Auto Exposure mode.

11. The device of claim 8, wherein
said second processing operation includes an image recording operation, and
when said detector detects said object being moved closer than said second predetermined distance, said controller executes said image recording operation.

12. The device of claim 1, wherein
when in said first processing operation, said detector detects said object being moved beyond said first predetermined distance, said controller returns said device to a normal mode.

13. The device of claim 7, wherein
when said vertically projected position falls within a first area on said detection surface, said controller places said device into a multi Auto Focus mode.

14. The device of claim 13, wherein
when said vertically projected position is detected as being moved to a second area on said detection surface, said controller places said device into a spot Auto Focus mode.

15. The device of claim 14, wherein
when said vertically projected position is subsequently detected as being returned to the first area on said detection surface, said controller returns said device into the multi Auto Focus/Auto Exposure mode.

16. The device of claim 13, wherein
said second processing operation includes an image recording operation, and
when said detector detects said object being moved closer than said second predetermined distance, said controller executes said image recording operation.

17. The device of claim 13, wherein
when in said first processing operation, said detector detects said object being moved beyond said first predetermined distance or detects said vertically projected position being moved outside of a multi Auto Focus detection area, said controller returns said device to a normal mode.

18. The device of claim 1, further comprising:
a display, wherein
said first processing operation includes locking a spot auto focus operation within a displayed image at a corresponding position on said detection surface that is proximate to the object, and
said controller causes a display of an indication of said spot auto focus being locked until said object is moved beyond a detection range of said detector.

19. The device of claim 1, further comprising:
a display, wherein
said first processing operation includes locking a multi auto focus operation at a plurality of areas, and
said controller causes a display of an indication of said multi auto focus operation being locked until said object is moved beyond a detection range of said detector.

20. The device of claim 1, wherein
said detector is configured to detect when the object has moved within a third predetermined distance of the detection surface, and
when said device is in the first processing operation or the second processing operation, said controller causes said device to change to a normal mode when the object is detected as moving to the third predetermined distance, wherein the third predetermined distance is further than the first predetermined distance or second predetermined distance.

21. The device of claim 1, wherein
said controller executes an image capture and recording operation when the detector detects said object as moving to a distance further than the second predetermined distance, said second predetermined distance being greater than the first predetermined distance.

22. The device of claim 1, wherein
said controller adjusts an image transmission speed on a display as a function of a distance between the object and the detection surface.

23. The device of claim 1, further comprising:
an image sensor, wherein
the first processing operation includes a multi Auto Exposure mode that controls an image exposure for a plurality of regions in a field of view of the image sensor.

24. The device of claim 1, wherein
said detector includes a transparent capacitance touch panel.

25. The device of claim 1, wherein
said detector is at least one of
an electromagnetic induction touch panel,
an optical touch panel, and
and image recognition touch panel.

26. The device of claim 22, wherein
said controller sets said device in an image transmission mode based on a projected position of said object being detected within a predetermined area, and changes the image transmission speed based on the distance of said object to said detection surface.

27. The device of claim 26, wherein
when the object is detected as being a constant distance from said detection surface, the image transmission speed is held constant.

28. The device of claim 26, wherein
when the object is detected as being further than a third predetermined distance from said detection surface, the transmission speed is stopped.

29. The device of claim 28, wherein
when the object is detected as being less than a third predetermined distance from the detection surface, the transmission speed is renewed at a higher constant speed than a constant speed prior to being stopped.

30. The device of claim 1, further comprising:
a display; and
a storage device that has video stored therein, wherein
said controller adjusts a playback speed of said video based on a distance of the object to the detection surface.

31. An input control method comprising:
detecting with a detector a presence of an object that is within a first predetermined distance of a detection surface;
executing with a controller a first processing operation when the detector detects the object being within the first predetermined distance;
detecting with the detector a second predetermined distance of the object to the detection surface; and
executing a related second processing operation when the detector detects the object being within the second predetermined distance.

32. A non-transitory computer readable storage device having instructions stored therein that when executed by a processing circuit perform an input control method comprising:
detecting a presence of an object that is within a first predetermined distance of a detection surface;
executing with the processing circuit a first processing operation when the detector detects the object being within the first predetermined distance;
detecting a second predetermined distance of the object to the detection surface; and
executing a related second processing operation when the detector detects the object being within the second predetermined distance.
